(19) United States
(12) Patent Application Publication
(10) Pub. No.: US 2024/0169446 A1
(43) Pub. Date: May 23, 2024

(54) COMPUTING SYSTEM FOR USE IN OUTPUTTING CANDIDATE TAX CATEGORIES FOR AN ARTICLE

(71) Applicant: Vertex, Inc., King of Prussia, PA (US)

(72) Inventor: Lizaveta Dauhiala, Minsk (BY)

(21) Appl. No.: 18/058,665

(22) Filed: Nov. 23, 2022

(51) Int. Cl. G06Q 40/12

(52) U.S. Cl. CPC G06Q 40/123

(57) ABSTRACT

A computing system is provided, including a processor configured to, during an inference phase, receive an article and input the article to an article embedding encoder to generate article embeddings, and generate, via a category embedding encoder, tax category embeddings. The processor is further configured to perform a similarity search between the tax category embeddings and the article embeddings, and classify the article into one or more candidate tax categories based on the similarity search result. The processor is further configured to concatenate the article with each of the candidate tax categories to form a plurality of input pairs and input the pairs to a ML model to determine a respective confidence score for classifying the article into each of the candidate tax categories for each of the pairs. The processor is further configured to output the candidate tax categories for the article and respective confidence scores.

### BACKGROUND

Tax experts and professionals review tax-related laws, regulations, and articles to stay up to date. These laws, regulations, and articles, which are often composed of hundreds or thousands of pages of text, often describe tax rules or rates regarding certain tax categories. These tax categories are important to understand the laws, regulations, and tax articles. Thus, being able to efficiently identify these tax categories within the voluminous text of these documents would allow tax experts and professionals to work more efficiently. Current approaches to identification include manually reading the entire text of these articles, which takes significant time and incurs a great cost. Keyword searching digital versions of the texts of the articles is also possible, but suffers from the drawback of missing or misidentifying certain tax categories. Since the impact of the laws and regulations can be significant, manual reading of the articles is still preferred to reduce the possibility of such errors, despite the great time and cost of doing so.

### SUMMARY

To address the issues discussed herein, a computerized system is provided, including a processor configured to, during an inference phase, receive an article and input the article to an article embedding encoder to generate article embeddings. The processor is further configured to generate, via a category embedding encoder, tax category embeddings. The processor is further configured to perform a similarity search between the tax category embeddings and the article embeddings and classify the article into one or more candidate tax categories based on a result of the similarity search. The processor is further configured to concatenate the article with each of the candidate tax categories to form a plurality of input pairs and input the input pairs to a trained machine learning (ML) model. The processor is further configured to determine, via the trained ML model, a respective confidence score for classifying the article into each of the candidate tax categories for each of the input pairs. The processor is further configured to output the candidate tax categories for the article and the respective confidence scores.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram of a computing system configured to train an untrained or not fully trained machine learning (ML) model to determine a confidence score for classifying an article into candidate tax categories, according to one example implementation of the present disclosure.

FIG. 2 is a schematic diagram of the computing system configured to determine, via the trained ML model of the system of FIG. 1, a confidence score for classifying the article into each of the candidate tax categories, during an inference phase.

FIG. 3 shows a schematic workflow of the system of FIG. 1 for generating an example ranked list of the candidate tax categories ranked by the confidence scores.

FIG. 4 shows a flowchart of a computerized method according to one example implementation of the computing system of FIG. 1 during a training phase.

FIG. 5 shows a flowchart of a computerized method according to one example implementation of the computing system of FIG. 2 during an inference phase.

FIG. 6 shows a block diagram of an example computing system that may be utilized to implement the computing system of FIGS. 1 and 2.

### DETAILED DESCRIPTION

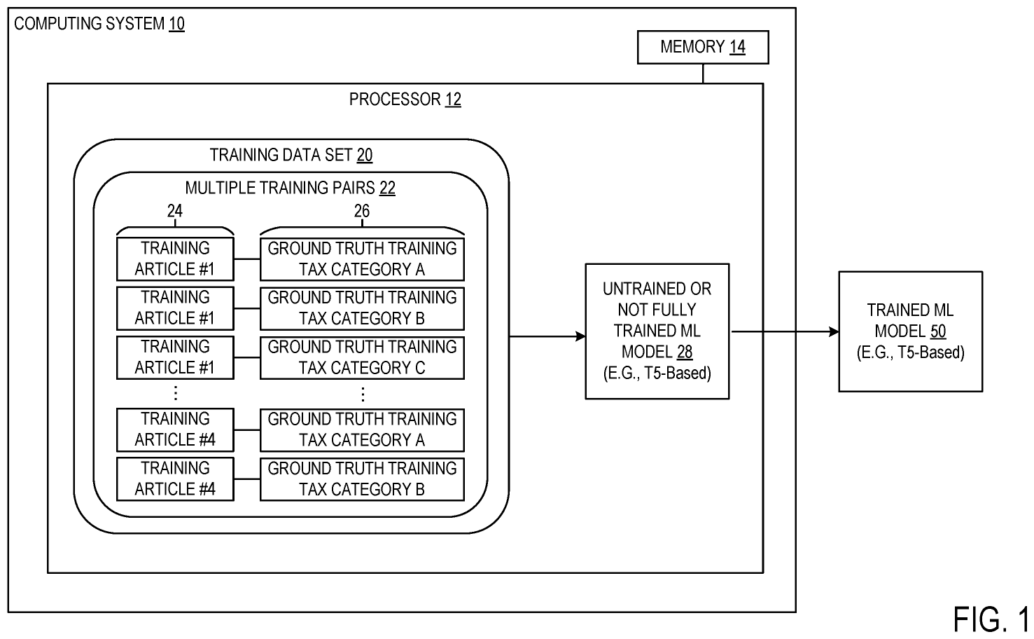

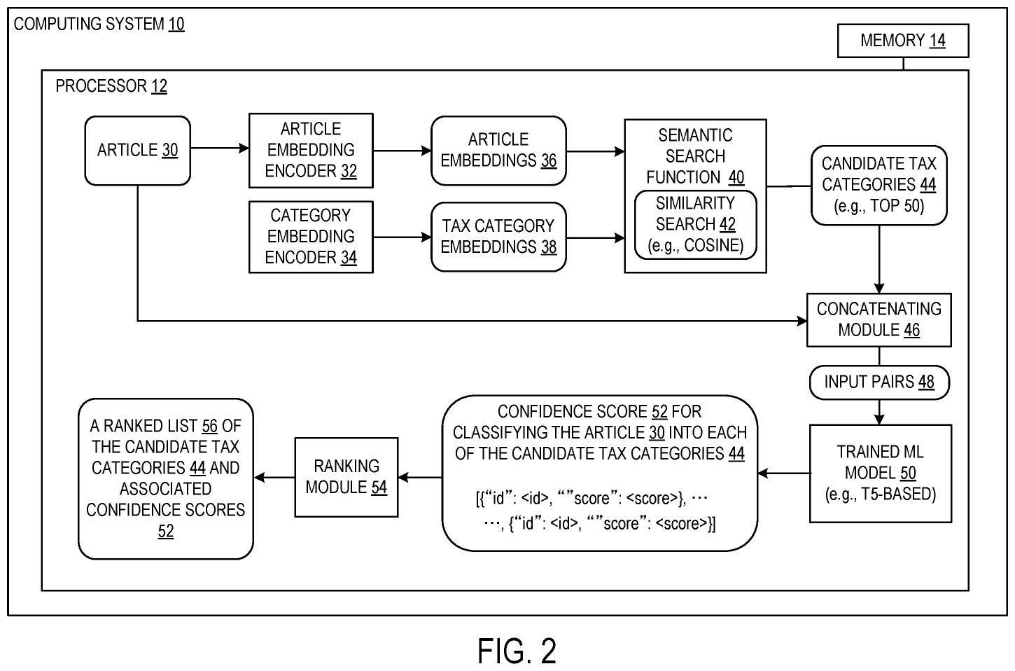

As schematically illustrated in FIGS. 1 and 2, to address the issues identified above, a computing system 10 for classifying tax categories is provided. FIG. 1 illustrates aspects of the system 10 during a training phase, that is, when an untrained or not fully trained ML model 28 is trained, while FIG. 2 illustrates aspects of the system 10 during inference time, that is, when a trained ML model 50 is applied to classify an article 30 into one or more candidate tax categories 44. As used herein a not fully trained ML model refers to a model that is partially trained or pre-trained on a first set of training data, and which is configured to be further trained on additional training data.

As illustrated in FIG. 1 the computing system 10 includes a processor 12 configured to train the untrained or not fully trained ML model 28 to determine a confidence score 52 (see FIG. 2) for classifying the article 30 into each of the candidate tax categories 44 for each of the input pairs 48 (see FIG. 2) during a training phase. Continuing with FIG. 1, the computing system 10 may include one or more processors 12 having associated memory 14. For example, the computing system 10 may include a cloud server platform including a plurality of server devices, and the one or more processors 12 may be one processor of a single server device, multiple processors of a single server device, or multiple processors distributed across multiple server devices. The computer system 10 may also include one or more client devices in communication with the server devices, in which one or more of processors 12 may be situated in such a client device. Typically, training-time and inference-time operations are executed on different devices (e.g., a first computing device and a second computing device) of the computer system, although they may be executed by the same device. Below, the functions of computing system 10 will be described as being executed by the processor 12 by way of example, and this description shall be understood to include execution on one or more processors distributed among one or more of the devices discussed above.

Continuing with FIG. 1, the associated memory 14 may store instructions that cause the processor 12 to receive a training data set 20 including multiple training pairs 22, in which each training pair 22 includes a respective training article 24 and a ground truth training tax category 26. The training articles 24 may be tax bills or articles regarding tax systems and rules that include a variety of tax categories such as personal care, grooming products, and skin care products. These particular categories are merely exemplary. Features in the text itself, such as the format in which the tax categories are written and the relative positional relationship of the tax categories to other words in the text can be encoded as embeddings that enable the models described herein to learn features associated with these data types and make inferences regarding whether a particular passage of text contains one of the data types, i.e., a tax category, etc. Furthermore, negative or false training pairs (e.g., article k, category x) in which the training article of the pairs is irrelevant to the training category may be generated during model training and input into the untrained or not fully trained ML model 28 so that the ML model 28 learns to distinguish between positive and negative pairs. After receiving the training data set 20, the processor 12 may be further configured to input the training data set 20 to the untrained or not fully trained ML model 28 and train the ML model 28 to determine the confidence score 52 for classifying the article 30 (see FIG. 2) into each of the candidate tax categories 44 (see FIG. 2) for each of the input pairs 48 (see FIG. 2) to generate the trained ML model 50, which is used during an inference time as discussed below.

The untrained or not fully trained ML model 28 and the trained ML model 50 may be a T5-based transformer neural network model. T5 (Text-to-Text Transfer Transformer) based model is a Transformer based sequence-to-sequence model that uses a text-to-text approach. T5 utilizes both encoder and decoder blocks, unlike BERT which uses encoder blocks only. In this model, every task, including translation, question answering, and classification, is cast as feeding the model text as input and training it to generate some target text. In the depicted example, the untrained or not fully trained ML model 28 model is trained with the training pairs 22 of the training articles 24 and ground truth training tax categories 26, in which the articles and tax categories are input as query and document texts respectively. Further, the model is tuned to generate “true” and “false” tokens, depending on whether the tax category is relevant or not to the article. During an inference phase as discussed below, a softmax function is applied to logits of the “true” and “false” tokens to compute the confidence score 52 (see FIG. 2). Furthermore, during a training phase, the untrained or not fully trained ML model 28 may be configured to generate a list of the candidate tax categories for each article for multi-label classification, along with the respective confidence score for each candidate tax category.

FIG. 2 is a schematic diagram of the computing system 10 configured to determine, via the trained ML model 50, the confidence score 52 for classifying the article 30 into each of the candidate tax categories 44 for each of the input pairs 48 during an inference phase. The associated memory 14 executes stored instructions that cause the processor 12 to receive the article 30 and input the article 30 to an article embedding encoder 32 to generate article embeddings 36 during an inference phase. The article 30 may be a tax-related article, such as proposed or enacted legislative or regulatory text, including a tax bill, law, rule or regulation, that details, summarizes, outlines or illustrates taxes enacted by federal, state, or municipal or other taxing jurisdictions. The article 30 may be a tax article in a digital format such as text, PDF, and .doc, and may be short or lengthy. In some cases, the article 30 may consist of hundreds of pages that include various tax categories. The article 30 may be distributed to tax experts for analysis or tax professionals for study and research. The article embedding encoder 32 may be a BERT (Bidirectional Encoder Representations from Transformers) based encoder, for example, a modification of a pretrained BERT network which uses Siamese and triplet network structures to derive semantically meaningful sentence embeddings. The article embeddings 36 are one-dimensional tensor vectors which are processed as query embeddings in a semantic search function 40 as discussed below. The processor 12 may be further configured to generate, via a category embedding encoder 34, tax category embeddings 38. The category embedding encoder 34 may also be a BERT encoder similar to the article embedding encoder 32. The tax category embeddings 38 are one-dimensional tensor vectors that are processed as corpus embeddings in the semantic search function 40 as discussed below.

The semantic search function 40 receives input of the article embeddings 36 as query embeddings and the category embeddings 38 as corpus embeddings and performs a similarity search 42 between the list of query embeddings (article embeddings 36) and the list of corpus embeddings (tax category embeddings 38). The similarity search 42 may be a cosine similarity search, for example. Upon completion of the similarity search, the semantic search function 40 generates a scored list of the candidate tax categories 44 which comprises similarity scores corresponding to respective top scoring candidate tax categories 44 for the article 30 to classify the article 30 into one or more candidate tax categories 44 based on the result of the similarity search 42 via the semantic function 40. A predetermined number (e.g., top 50) of the candidate tax categories may be generated based on the similarity scores. Alternatively, a predetermined cosine similarity score threshold (e.g., 0.6 or above) may be used to generate the candidate tax categories 44 in the cosine similarity search, in which the candidate tax categories 44 with the predetermined cosine similarity score or above may be selected. It will be appreciated that a varying number of candidate tax categories may be above the threshold. A set of one or more candidate tax categories is selected when one or more similarity scores are above the threshold, but if no similarity scores are above the threshold, then no categories are selected. The processor 12 may be further configured to concatenate, via a concatenate module 46, the article 30 with the candidate tax categories 44 output by the semantic search function 40 as the input pairs 48. For example, the input pairs 48 may be generated as (article #1, category A), (article #1, category B) . . . (article #1, category N).

The processor 12 may be further configured to input the input pairs 48 to the trained ML model 50 and determine, via the trained ML model 50, a respective confidence score 52 for classifying the article 30 into each of the candidate tax categories 44 for each of the input pairs 48. The confidence score 52 is determined by computing probabilities for the true and false tokens generated via the trained ML model 50, in which the tokens depend on whether each of the tax categories 44 is relevant or not to the article 30. To compute the probabilities, the softmax function is applied to the logits of the “true” and “false” tokens to compute the confidence score 52. The softmax function is a mathematical function that converts a vector of numbers into a vector of probabilities, where the probabilities of each value are proportional to the relative scale of each value in the vector. The processor 12 may be further configured to output the candidate tax categories 44 for the article 30 and the respective confidence scores 52. The outputting may be performed by a ranking module 54, and the output may take the form of a ranked list 56. The ranked list 56 may include a predetermined number of the candidate tax categories 44 ranked by the confidence scores 52. For example, the predetermined number of the candidate tax categories 44 may be the top 10 of the candidate tax categories 44 ranked by the confidence scores 52, provided at least 10 candidate tax categories had similarity scores above the threshold. Alternatively, the selected set of candidate tax categories 44 may be selected using an algorithm that optimizes the threshold to reduce false positives, in which the recommendations on the candidate tax categories 44 are evaluated by users who give feedback on their accuracy, for example, by labeling certain recommendations as false positives, and then the number of recommendations is tuned to minimize the false positives. The ranked list 56 of the candidate tax categories 44 may be output to a client computing device of a user (e.g., a tax expert or professional) which is communicatively coupled to the computing system 10 via a network. The network may take the form of a local area network (LAN), wide area network (WAN), wired network, wireless network, personal area network, or a combination thereof, and can include the Internet. Alternatively, the candidate tax categories and confidence scores may be output in another form, such as an unsorted array of tuples, etc.

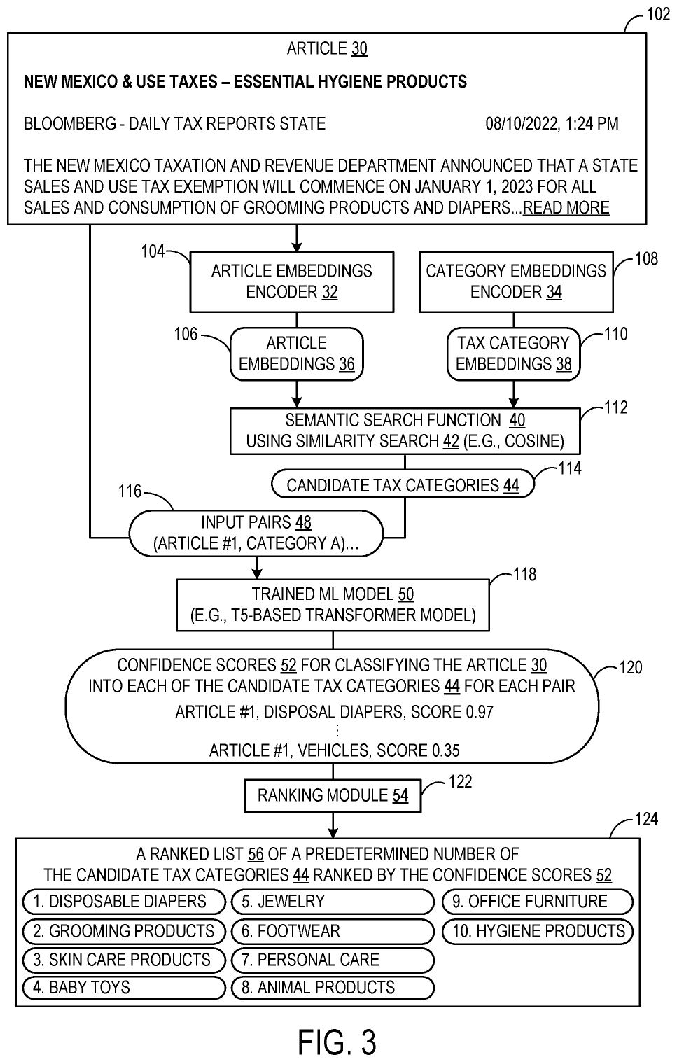

FIG. 3 shows an example workflow for generating an example ranked list 56 of the candidate tax categories 44 ranked by the confidence scores 52, via the system 10. In the depicted example, as shown at 102, the article 30 features tax-related updates which include multiple tax categories. As shown at 104, the article 30 is input into the article embedding encoder 32, which generates the article embeddings 36 as shown at 106. As shown, tax categories embeddings 38 are generated at 108 via the category embedding encoder 34, and are output at 110. At 112, the generated article embeddings 36 and tax categories embeddings 38 are input into the semantic search function 40 that performs the similarity search 42 (e.g., cosine similarity) between the article embeddings 36 and the tax category embeddings 38 to classify the article 30 into the candidate tax categories 44 based on the result of the similarity search 42. At 114, the candidate tax categories are outputted from the semantic search function 40. As shown at 116, the input pairs 48, [e.g., (article #1,category A), (article #1,category B) . . . (article #1,category N)], are generated by concatenating the article 30 with the candidate tax categories 44 and input into the trained ML model 50. At 118, the trained ML model 50 receives the input pairs 48 as input and determines the confidence score 52 for classifying the article 30 into each of the candidate tax categories 44 for each of the input pairs 48. The confidence scores are output from the trained ML model at 120. As shown, the candidate tax categories 44 and respective confidence scores 52 are input, at 122, into the ranking module 54 to output, at 124, the example ranked list 56 of the top ten candidate tax categories 44 for the article 30. The example ranked list is shown to include “DISPOSABLE DIAPERS,” “GROOMING PRODUCTS,” and “SKIN CARE PRODUCTS,” among others.

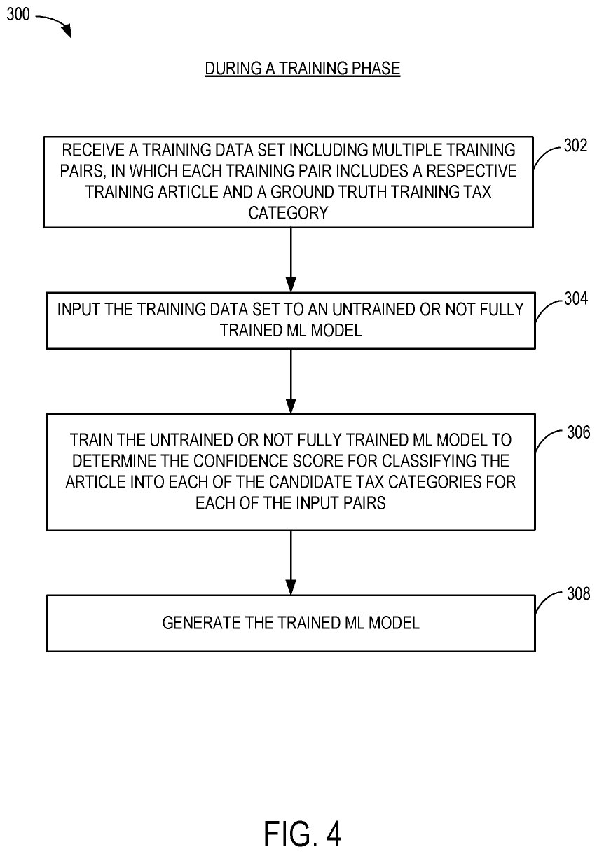

FIG. 4 shows a flowchart of a computerized method 300 according to one example implementation, during a training phase. Method 300 may be implemented via the computing system of FIG. 1, or other suitable hardware and software components. At step 302, the method may include receiving a training data set including multiple training pairs, in which each training pair includes a respective training article and a ground truth training tax category. At step 304, the method may further include inputting the training data set to an untrained or not fully trained ML model. At step 306, the method may further include training the untrained or not fully trained ML model to determine the confidence score classifying the article into each of the candidate tax categories for each of the input pairs, to thereby generate the trained ML model. At step 308, the method may further include generating the trained ML model, based on the training at step 306.

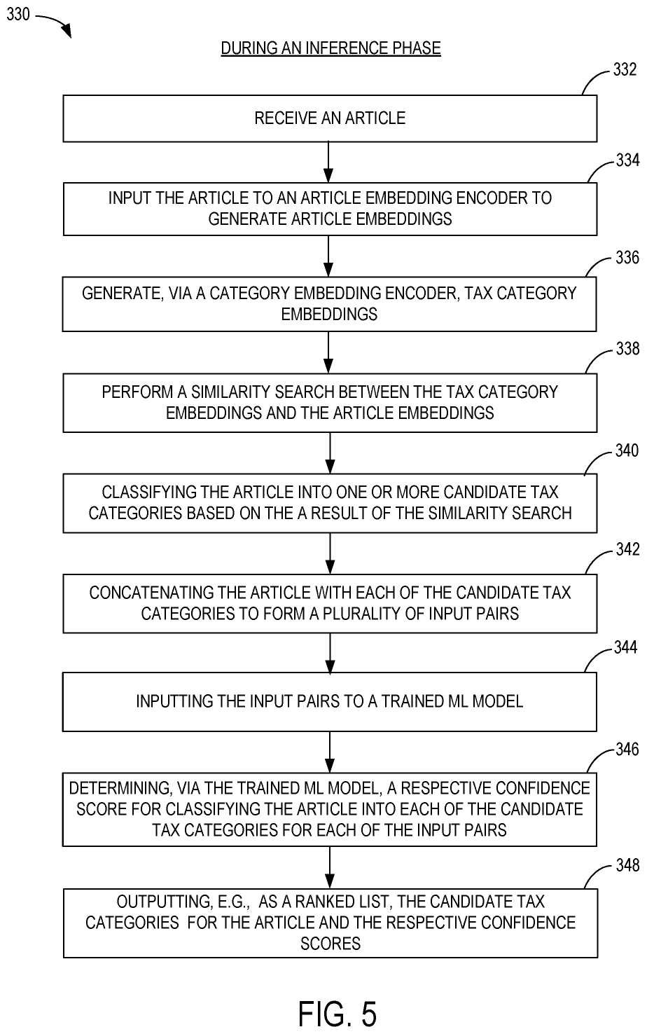

FIG. 5 shows a flowchart of a computerized method 330 according to one example implementation, at inference time. Method 330 may be implemented using the computing system of FIG. 2, or via other suitable hardware and software components. At step 332, the method may include receiving an article. At step 334, the method may include inputting the article to an article embedding encoder to generate article embeddings. At step 336, the method may further include generating, via a category embedding encoder, tax category embeddings. At step 338, the method may further include performing a similarity search between the tax category embeddings and the article embeddings. At step 340, the method may further include classifying the article into one or more candidate tax categories based on a result of the similarity search. At step 342, the method may further include concatenating the article with each of the candidate tax categories to form a plurality of input pairs. At step 344, the method may further include inputting the input pairs to a trained ML model. At step 346, the method may further include determining, via the trained ML model, a respective confidence score for classifying the article into each of the candidate tax categories for each of the input pairs. At step 348, the method may further include outputting the candidate tax categories for the article and the respective confidence scores, for example, as a ranked list.

The above described systems and methods may be implemented to enable processing of large volumes of textual articles in a short amount of time to quickly identify tax effective dates, as well as tax rates and/or tax amounts, thereby increasing the speed at which companies monitoring changes in tax laws globally can identify such changes in those tax laws in particular jurisdictions. In addition to saving time, the systems and methods described herein provide a technical solution that potentially saves on the cost of such tax research by minimizing the time spent by tax experts and analysts to perform this task.

In some embodiments, the methods and processes described herein may be tied to a computing system of one or more computing devices. In particular, such methods and processes may be implemented as a computer-application program or service, an application-programming interface (API), a library, and/or other computer-program product.

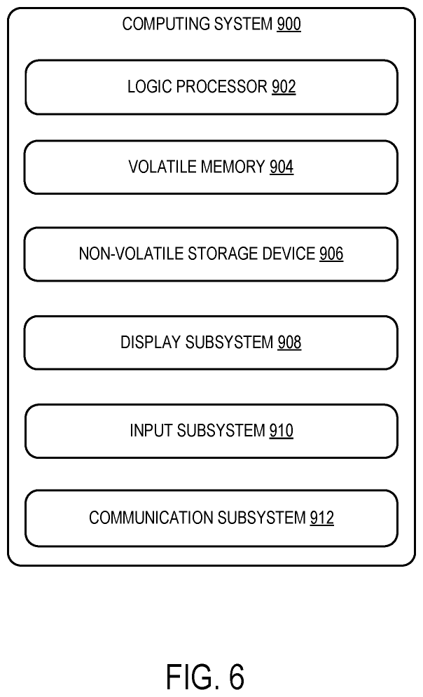

FIG. 6 schematically shows a non-limiting embodiment of a computing system 900 that can enact one or more of the methods and processes described above. Computing system 900 is shown in simplified form. Computing system 900 may embody the computing system 10 described above and illustrated in FIGS. 1 and 2. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 904, and a non-volatile storage device 906. Computing system 900 may optionally include a display subsystem 908, input subsystem 910, communication subsystem 912, and/or other components not shown in FIG. 6.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed, e.g., to hold different data.

Non-volatile storage device 906 may include physical devices that are removable and/or built in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a processor configured to:
during an inference phase,
receive an article;
input the article to an article embedding encoder to generate article embeddings;
generate, via a category embedding encoder, tax category embeddings;
perform a similarity search between the tax category embeddings and the article embeddings;
classify the article into one or more candidate tax categories based on a result of the similarity search;
concatenate the article with each of the candidate tax categories to form a plurality of input pairs;
input the input pairs to a trained machine learning (ML) model;
determine, via the trained ML model, a respective confidence score for classifying the article into each of the candidate tax categories for each of the input pairs; and
output the candidate tax categories for the article and the respective confidence scores.

2. The computing system of claim 1, wherein the article embedding encoder is a BERT (Bidirectional Encoder Representations from Transformers) encoder.

3. The computing system of claim 1, wherein the category embedding encoder is a BERT (Bidirectional Encoder Representations from Transformers) encoder.

4. The computing system of claim 1, wherein
the similarity search is a cosine similarity search; and
a predetermined cosine similarity score threshold is used to generate the candidate tax categories in the cosine similarity search.

5. The computing system of claim 1, wherein the confidence score is determined by computing probabilities for true and false tokens.

6. The computing system of claim 1, wherein
the candidate tax categories for the article and the respective confidence scores are outputted in a ranked list; and

7. The computing system of claim 6, wherein
the ranked list includes a predetermined number of the candidate tax categories ranked by the confidence scores.

8. The computing system of claim 1, wherein the processor is further configured to:
during a training phase,
receive a training data set including multiple training pairs, each training pair including a respective training article and a ground truth training tax category;
input the training data set to an untrained or not fully trained ML model; and
train the untrained or not fully trained ML model to determine the confidence score for classifying the article into each of the candidate tax categories for each of the input pairs, to thereby generate the trained ML model.

9. The computing system of claim 8, wherein the trained ML model is a T5-based transformer neural network model.

10. A computerized method, comprising:
during an inference phase,
receiving an article;
inputting the article to an article embedding encoder to generate article embeddings;
generating, via a category embedding encoder, tax category embeddings;
performing a similarity search between the tax category embeddings and the article embeddings;
classifying the article into one or more candidate tax categories based on a result of the similarity search;
concatenating the article with each of the candidate tax categories to form a plurality of input pairs;
inputting the input pairs to a trained machine learning (ML) model;
determining, via the trained ML model, a respective confidence score for classifying the article into each of the candidate tax categories for each of the input pairs; and
outputting the candidate tax categories for the article and the respective confidence scores.

11. The computerized method of claim 10, wherein the article embedding encoder is a BERT (Bidirectional Encoder Representations from Transformers) encoder.

12. The computerized method of claim 10, wherein the category embedding encoder is a BERT (Bidirectional Encoder Representations from Transformers) encoder.

13. The computerized method of claim 10, wherein
the similarity search is a cosine similarity search; and
a predetermined cosine similarity score threshold is used to generate the candidate tax categories in the cosine similarity search.

14. The computerized method of claim 10, wherein the confidence score is determined by computing probabilities for true and false tokens.

15. The computerized method of claim 10, wherein the candidate tax categories for the article and the respective confidence scores are outputted in a ranked list.

16. The computerized method of claim 15, wherein the ranked list includes a predetermined number of the candidate tax categories ranked by the confidence scores.

17. The computerized method of claim 10, further comprising:
during a training phase,
receiving a training data set including multiple training pairs, each training pair including a respective training article and a ground truth training tax category;
inputting the training data set to an untrained or not fully trained ML model; and
training the untrained or not fully trained ML model to determine the confidence score classifying the article into each of the candidate tax categories for each of the input pairs, to thereby generate the trained ML model.

18. A computing system, comprising:
a processor configured to:
during a training phase,
receive a training data set including multiple training pairs, each training pair including a respective training article and a ground truth training tax category;
input the training data set to an untrained or not fully trained ML model; and
train the untrained or not fully trained ML model to determine the confidence score for classifying the article into each of the candidate tax categories for each of the input pairs, to thereby generate a trained ML model; and
during an inference phase,
receive an article;
input the article to an article embedding encoder to generate article embeddings;
generate, via a category embedding encoder, tax category embeddings;
perform a similarity search between the tax category embeddings and the article embeddings;
classify the article into one or more candidate tax categories based on a result of the similarity search;
concatenate the article with each of the candidate tax categories to form a plurality of input pairs;
input the input pairs to the trained machine learning (ML) model;
determine, via the trained ML model, a respective confidence score for classifying the article into each of the candidate tax categories for each of the input pairs;
output a ranked list of the candidate tax categories for the article and the respective confidence scores.

19. The computing system of claim 18, wherein
the similarity search is a cosine similarity search; and
a predetermined cosine similarity score threshold is used to extract the candidate tax categories in the cosine similarity search.

20. The computing system of claim 18, wherein the trained ML model is a T5-based transformer neural network model.
